(19) United States
(12) Patent Application Publication
(10) Pub. No.: US 2021/0329348 A1
(43) Pub. Date: Oct. 21, 2021

(54) MEMORY MANAGEMENT IN ADVANCED TELEVISION SYSTEMS COMMITTEE (ATSC) 3.0 SYSTEM

(71) Applicant: Sony Corporation, Tokyo (JP)

(72) Inventors: Steven Richman, San Diego, CA (US); Tanmay Agnihotri, San Diego, CA (US)

(21) Appl. No.: 16/851,030

(22) Filed: Apr. 16, 2020

(51) Int. Cl. H04N 21/81; H04N 21/2543; H04N 21/2668; H04N 21/431; G06Q 30/02

(52) U.S. Cl. CPC H04N 21/812; H04N 21/25435; G06Q 30/0241; H04N 21/4316; H04N 21/2668

(57) ABSTRACT

Techniques for using Xlinks for multiple advertisement tags to be applied together as an ad event, triggered by metadata that may be carried in, e.g., an ATSC 3.0 media presentation description (MPD) or separately as individual ad tags each of which may be programmable. Ad events are timed, JavaScript-controlled, TV canvas presentations using XLinks to signal an ad avail to which there are multiple ad choices that can be chosen for display. Multiple ad tags get treated as an Ad event, the timing and syncing of ads for an ad event, programmable ads that serve not only a single purpose but can morph from a single function to multi-function, ads that serve multiple functions (generate coupon or to generate monetization information), and ads that are monetized that have attribution built in to their display. Once finished the ad records its playout details (time, location, even profile of viewer).

### FIELD

This application relates to technical advances necessarily rooted in computer technology and directed to digital television, and more particularly to Advanced Television Systems Committee (ATSC) 3.0.

### BACKGROUND

The Advanced Television Systems Committee (ATSC) 3.0 suite of standards is a set of over a dozen industry technical standards as indicated in A/300 for delivering the next generation of broadcast television. ATSC 3.0 supports delivery of a wide range of television services including televised video, interactive services, non-real time delivery of data, and tailored advertising to a large number of receiving devices, from ultra-high definition televisions to wireless telephones. ATSC 3.0 also orchestrates coordination between broadcast content (also referred to as “over the air” or “OTA”) and related broadband delivered content and services (also referred to as “over the top” or “OTT”). ATSC 3.0 is designed to be flexible so that as technology evolves, advances can be readily incorporated without requiring a complete overhaul of any related technical standard. Present principles are directed to such advances as divulged below

### SUMMARY

As used herein, an “ad event” refers to the presentation of multiple advertisements in a broadcast and/or broadband stream. The term “ad avail” is also used herein to refer to an upcoming or scheduled ad event.

Present principles are concerned with multiple metadata tags (advertisement tags) that may be applied together as an ad event, triggered by metadata that may be carried in, e.g., an ATSC 3.0 media presentation description (MPD), specifically the ATSC 3.0 metadata element known as an XLink, or separately as individual ad tags each of which may be programmable. Ad events are timed, JavaScript-controlled, TV canvas presentations using XLinks to signal an ad avail to which there are multiple ad choices that can be chosen for display.

The description herein identifies how multiple ad tags get treated as an Ad event, the timing and syncing of ads for an ad event, programmable ads that serve not only a single purpose but can morph from a single function to multi-function, ads that serve multiple functions such as to generate coupon or to generate monetization information, and ads that are monetized that have attribution built in to their display. Once finished the ad records its playout details (time, location, even profile of viewer).

Accordingly, in one aspect an assembly includes at least one receiver device that in turn includes at least one display, at least one broadcast signal receiver, and at least one processor configured with instructions which when executed by the processor configure the processor to receive from the broadcast receiver at least one audio video (AV) stream for live presentation of the AV stream on the display. The instructions also are executable to receive at least one non-real time (NRT) content comprising at least first and second advertisements for insertion of the NRT content into the AV stream, and to present on the display the first and second advertisements.

In non-limiting implementations presenting the first and second advertisements includes presenting an ad event in accordance with at least one template that may be written in JavaScript. The template can define what advertisements in a group of advertisements are to be used as the first and second advertisements in the ad event, as well as identify respective locations on the display at which each of the first and second advertisements is to be presented and respective durations for presenting the first and second advertisements. The template may be associated with a broadcaster application.

In some examples the ad event is identified by metadata from a broadcast transmitter and/or from a network server. The metadata may be an Xlink and the Xlink may be part of a media presentation description (MPD). The ad event can be associated with at least first and second ad IDs identifying the respective first and second advertisements.

In another aspect, in a digital television system, a method includes generating a signal of an advertisement availability (Ad avail). The method also includes inserting the signal into a video stream receivable by a receiver, sending a template to the receiver, and using the template, identifying plural advertisements (ads). The method further includes storing the ads in storage of the receiver and, using the template, presenting the plural ads on a display of the receiver at locations and for durations controlled by the template.

In some embodiments the video stream includes a digital TV broadcast stream and/or a stream sent to the receiver from a network server. The ad avail signal may include an Xlink.

In non-limiting examples, at least a first ad of the plural ads includes computer software to update the first ad over time. In other examples at least a first ad of the plural ads includes computer software to generate information useful for monetization.

In another aspect, a digital broadcast television (TV) assembly includes at least one broadcaster assembly configured for broadcasting an audio video (AV) stream. Non-real time (NRT) content is associated with the AV stream. The assembly also includes at least one receiver device configured for receiving the AV stream and the NRT content. The NRT content includes at least first and second advertisements presentable on the receiver device together as a single ad event under control of a processor-executable template.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an Advanced Television Systems Committee (ATSC) 3.0 system;

FIG. 2 is a block diagram showing components of the devices shown in FIG. 1;

FIG. 3 is a block diagram of an example receiver with example types of memories;

FIG. 4 illustrates example relationships between an MPD, an Xlink, and advertising;

FIG. 5 illustrates an example relationship between an ad event and ads;

FIG. 6 illustrates an example screen shot showing an ad event;

FIG. 7 illustrates an example relationship between an Xlink URL, ads, and an ad template;

FIG. 8 illustrates an example screen shot showing an ad event;

FIG. 9 illustrates an example screen shot showing an ad event;

FIG. 10 illustrates an example digital wall;

FIG. 11 illustrates example logic in example flow chart format consistent with present principles;

FIG. 12 illustrates an example dynamic ad;

FIG. 13 illustrates an example screen shot showing an ad event with a “smart” ad that updates itself; and

FIG. 14 illustrates an example screen shot showing another example ad event.

### DETAILED DESCRIPTION

This disclosure relates to technical advances in Advanced Television Systems Committee (ATSC) 3.0 television. A system herein may include ATSC 3.0 source components and client components, connected via broadcast and/or over a network such that data may be exchanged between the client and ATSC 3.0 source components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google, such as Android©. These operating environments may be used to execute one or more browsing programs, such as a browser made by Microsoft or Google or Mozilla or other browser program that can access websites hosted by the Internet servers discussed below.

ATSC 3.0 source components may include broadcast transmission components and servers and/or gateways that may include one or more processors executing instructions that configure the source components to broadcast data and/or to transmit data over a network such as the Internet. A client component and/or a local ATSC 3.0 source component may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to hypertext markup language (HTML)-5, Java®/Javascript, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

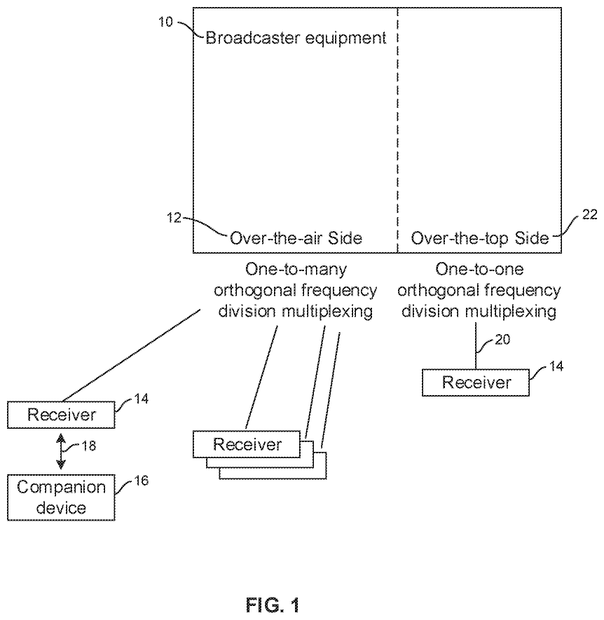

Turning to FIG. 1, an example of an ATSC 3.0 source component is labeled “broadcaster equipment” 10 and may include over-the-air (OTA) equipment 12 for wirelessly broadcasting, typically via orthogonal frequency division multiplexing (OFDM) in a one-to-many relationship, television data to plural receivers 14 such as ATSC 3.0 televisions. One or more receivers 14 may communicate with one or more companion devices 16 such as remote controls, tablet computers, mobile telephones, and the like over a short range, typically wireless link 18 that may be implemented by Bluetooth©, low energy Bluetooth, other near field communication (NFC) protocol, infrared (IR), etc.

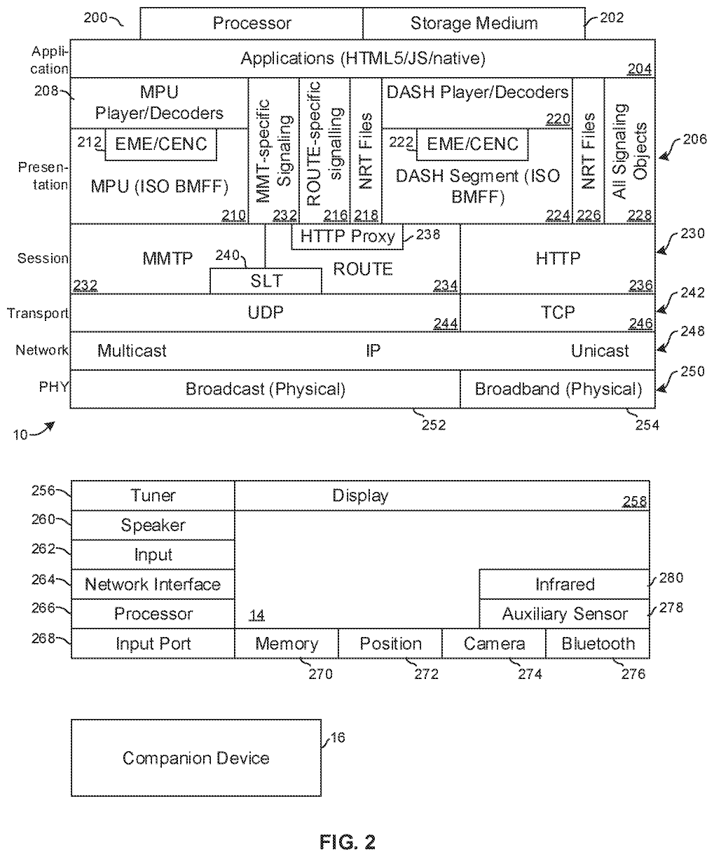

Also, one or more of the receivers 14 may communicate, via a wired and/or wireless network link 20 such as the Internet, with over-the-top (OTT) equipment 22 of the broadcaster equipment 10 typically in a one-to-one relationship. The OTA equipment 12 may be co-located with the OTT equipment 22 or the two sides 12, 22 of the broadcaster equipment 10 may be remote from each other and may communicate with each other through appropriate means. In any case, a receiver 14 may receive ATSC 3.0 television signals OTA over a tuned-to ATSC 3.0 television channel and may also receive related content, including television, OTT (broadband). Note that computerized devices described in all of the figures herein may include some or all of the components set forth for various devices in FIGS. 1 and 2.

Referring now to FIG. 2, details of the components shown in FIG. 1 may be seen. FIG. 2 illustrates the broadcaster equipment 10 in terms of a protocol stack that may be implemented by a combination of hardware and software. As discussed below, using the ATSC 3.0 protocol stack, broadcasters can send hybrid service delivery in which one or more program elements are delivered via a computer network (referred to herein as “broadband” and “over-the-top” (OTT)) as well as via a wireless broadcast (referred to herein as “broadcast” and “over-the-air” (OTA)).

The broadcaster equipment 10 can include one or more processors 200 accessing one or more computer storage media 202 such as any memories or storages described herein to execute one or more software applications in a top-level application layer 204. The application layer 204 can include one or more software applications written in, e.g., HTML5/Javascript running in a runtime environment. Without limitation, the applications in the application stack 204 may include linear TV applications, interactive service applications, companion screen applications, personalization applications, emergency alert applications, and usage reporting applications. The applications typically are embodied in software that represents the elements that the viewer experiences, including video coding, audio coding and the run-time environment. As an example, an application may be provided that enables a user to control dialog, use alternate audio tracks, control audio parameters such as normalization and dynamic range, and so on.

Below the application layer 204 is a presentation layer 206. The presentation layer 206 includes, on the broadcast (OTA) side, broadcast audio-video playback devices referred to as “media playback units) (MPU) 208 that decode and playback, on one or more displays and speakers, wirelessly broadcast audio video content. The MPU 208 is configured to present International Organization for Standardization (ISO) base media file format (BMFF) data representations 210 and video in high efficiency video coding (HEVC) with audio in, e.g., Dolby audio compression (AC)-4 format. ISO BMFF is a general file structure for time-based media files broken into “segments” and presentation metadata. Each of the files is essentially a collection of nested objects each with a type and a length. To facilitate decryption, the MPU 208 may access a broadcast side encrypted media extensions (EME)/common encryption (CENC) module 212.

FIG. 2 further illustrates that on the broadcast side the presentation layer 206 may include signaling modules, including a motion pictures expert group (MPEG) media transport protocol (MMTP) signaling module 214 and a real-time object delivery over unidirectional transport (ROUTE) signaling module 216 for delivering non-real time (NRT) content 218 that is accessible to the application layer 204. NRT content may include but is not limited to stored replacement advertisements.

On the broadband (OTT or computer network) side, the presentation layer 206 can include one or more dynamic adaptive streaming over hypertext transfer protocol (HTTP) (DASH) player/decoders 220 for decoding and playing audio-video content from the Internet. To this end the DASH player 220 may access a broadband side EME/CENC module 222. The DASH content may be provided as DASH segments 224 in ISO/BMFF format.

As was the case for the broadcast side, the broadband side of the presentation layer 206 may include NRT content in files 226 and may also include signaling objects 228 for providing play back signaling.

Below the presentation layer 206 in the protocol stack is a session layer 230. The session layer 230 includes, on the broadcast side, MMTP protocol 232 and ROUTE protocol 234. MMTP wraps the ISO BMFF files with metadata for broadcast delivery. Essentially, MMTP contains pointers to signaling components that identify physical layer pipes (PL), each of which may be thought of as a separate video stream configured for a particular receiver type with source and destination identification information. Other signaling components typically are provided to aid in the playback of the audio video content.

On the broadband side the session layer 230 includes HTTP protocol 236 which may be implemented as HTTP-secure (HTTP(S). The broadcast side of the session layer 230 also may employ a HTTP proxy module 238 and a service list table (SLT) 240. The SLT 240 includes a table of signaling information which is used to build a basic service listing and provide bootstrap discovery of the broadcast content.

A transport layer 242 is below the session layer 230 in the protocol stack for establishing low-latency and loss-tolerating connections. On the broadcast side the transport layer 242 uses user datagram protocol (UDP) 244 and on the broadband side transmission control protocol (TCP) 246.

The protocol stack also includes a network layer 248 below the transport layer 242. The network layer 248 uses Internet protocol (IP) on both sides for IP packet communication, with multicast delivery being typical on the broadcast side and unicast being typical on the broadband side.

Below the network layer 248 is the physical layer 250 which includes broadcast transmission/receive equipment 252 and computer network interface(s) 254 for communicating on the respective physical media associated with the two sides. The physical layer 250 converts machine access code (MAC) format to be suitable to be transported over the relevant medium and may add forward error correction functionality to enable error correction at the receiver as well as contain modulation and demodulation modules to incorporate modulation and demodulation functionalities. This converts bits into symbols for long distance transmission as well as to increase bandwidth efficiency. On the OTA side the physical layer 250 typically includes a wireless broadcast transmitter to broadcast data wirelessly using orthogonal frequency division multiplexing (OFDM) while on the OTT side the physical layer 250 includes computer transmission components to send data over the Internet.

A DASH-industry forum (IF) profile sent through the various protocols (HTTP/TCP/IP) in the protocol stack may be used on the broadband side. Media files in the DASH-IF profile based on the ISO BMFF may be used as the delivery, media encapsulation and synchronization format for both broadcast and broadband delivery.

Each receiver 14 typically includes a protocol stack that is complementary to that of the broadcaster equipment.

A receiver 14 in FIG. 1 may include, as shown in FIG. 2, an Internet-enabled TV with a an ATSC 3.0 TV tuner (equivalently, set top box controlling a TV) 256. The receiver 14 may be an Android®-based system. The receiver 14 alternatively may be implemented by a computerized Internet enabled (“smart”) telephone, a tablet computer, a notebook computer, a wearable computerized device, and so on. Regardless, it is to be understood that the receiver 14 and/or other computers described herein is configured to undertake present principles (e.g. communicate with other devices to undertake present principles, execute the logic described herein, and perform any other functions and/or operations described herein).

Accordingly, to undertake such principles the receiver 14 can be established by some or all of the components shown in FIG. 1. For example, the receiver 14 can include one or more displays 258 that may be implemented by a high definition or ultra-high definition “4K” or higher flat screen and that may or may not be touch-enabled for receiving user input signals via touches on the display. The receiver 14 may also include one or more speakers 260 for outputting audio in accordance with present principles, and at least one additional input device 262 such as, e.g., an audio receiver/microphone for, e.g., entering audible commands to the receiver 14 to control the receiver 14. The example receiver 14 may further include one or more network interfaces 264 for communication over at least one network such as the Internet, a WAN, a LAN, a PAN etc. under control of one or more processors 266. Thus, the interface 264 may be, without limitation, a Wi-Fi transceiver, which is an example of a wireless computer network interface, such as but not limited to a mesh network transceiver. The interface 264 may be, without limitation, a Bluetooth© transceiver, Zigbee© transceiver, Infrared Data Association (IrDA) transceiver, Wireless USB transceiver, wired USB, wired LAN, Powerline or Multimedia over Coax Alliance (MoCA). It is to be understood that the processor 266 controls the receiver 14 to undertake present principles, including the other elements of the receiver 14 described herein such as, for instance, controlling the display 258 to present images thereon and receiving input therefrom. Furthermore, note the network interface 264 may be, e.g., a wired or wireless modem or router, or other appropriate interface such as, e.g., a wireless telephony transceiver, or Wi-Fi transceiver as mentioned above, etc.

In addition to the foregoing, the receiver 14 may also include one or more input ports 268 such as a high definition multimedia interface (HDMI) port or a USB port to physically connect (using a wired connection) to another CE device and/or a headphone port to connect headphones to the receiver 14 for presentation of audio from the receiver 14 to a user through the headphones. For example, the input port 268 may be connected via wire or wirelessly to a cable or satellite source of audio video content. Thus, the source may be a separate or integrated set top box, or a satellite receiver. Or, the source may be a game console or disk player.

The receiver 14 may further include one or more computer memories 270 such as disk-based or solid-state storage that are not transitory signals, in some cases embodied in the chassis of the receiver as standalone devices or as a personal video recording device (PVR) or video disk player either internal or external to the chassis of the receiver for playing back audio video (AV) programs or as removable memory media. Also, in some embodiments, the receiver 14 can include a position or location receiver 272 such as but not limited to a cellphone receiver, global positioning satellite (GPS) receiver, and/or altimeter that is configured to e.g. receive geographic position information from at least one satellite or cellphone tower and provide the information to the processor 266 and/or determine an altitude at which the receiver 14 is disposed in conjunction with the processor 266. However, it is to be understood that that another suitable position receiver other than a cellphone receiver, GPS receiver and/or altimeter may be used in accordance with present principles to determine the location of the receiver 14 in e.g. all three dimensions.

Continuing the description of the receiver 14, in some embodiments the receiver 14 may include one or more cameras 274 that may include one or more of a thermal imaging camera, a digital camera such as a webcam, and/or a camera integrated into the receiver 14 and controllable by the processor 266 to gather pictures/images and/or video in accordance with present principles. Also included on the receiver 14 may be a Bluetooth© transceiver 276 or other Near Field Communication (NFC) element for communication with other devices using Bluetooth© and/or NFC technology, respectively. An example NFC element can be a radio frequency identification (RFID) element.

Further still, the receiver 14 may include one or more auxiliary sensors 278 (such as a motion sensor such as an accelerometer, gyroscope, cyclometer, or a magnetic sensor and combinations thereof), an infrared (IR) sensor for receiving IR commands from a remote control, an optical sensor, a speed and/or cadence sensor, a gesture sensor (for sensing gesture commands) and so on providing input to the processor 266. An IR sensor 280 may be provided to receive commands from a wireless remote control. A battery (not shown) may be provided for powering the receiver 14.

The companion device 16 may incorporate some or all of the elements shown in relation to the receiver 14 described above.

The methods described herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

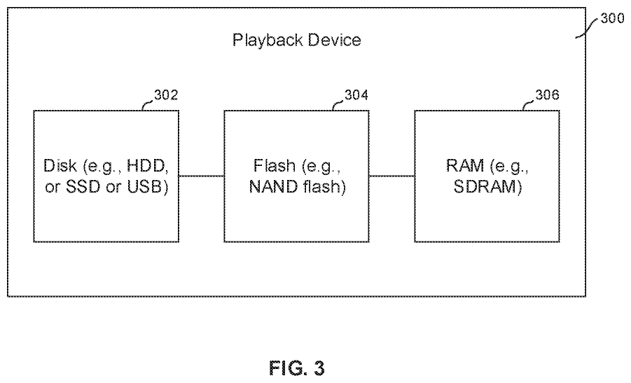

Now referring to FIG. 3, a playback device 300 may include any of the components discussed above in relation to FIGS. 1 and 2 and may further include a disk drive 302 such as a hard disk drive, an optical disk drive, a universal serial bus (USB) drive, and combinations thereof.

The disk drive 302 can communicate with other memories that may also communicate with each other for purposes to be shortly disclosed, including a flash memory 304 such as a not-and (NAND) flash and a random access memory (RAM) 306 such as a dynamic RAM (DRAM) and/or synchronous DRAM (SDRAM).

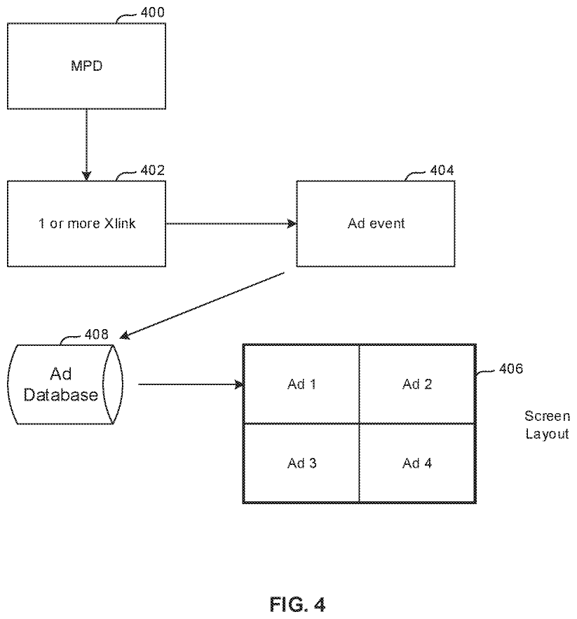

FIG. 4 illustrates an ATSC 3.0 media presentation description (MPD) 400 that includes metadata 402, in the example shown one or more extensible markup language (XML) links (XLink) that define at least one ad event 404. The ad event 404 may be a timed, JavaScript-controlled, TV canvas presentation using XLinks to signal an ad avail to which there are multiple ad choices 406 in an ad database 408 that may be controlled by a user agent such as a receiver's broadcaster application that can be chosen for display.

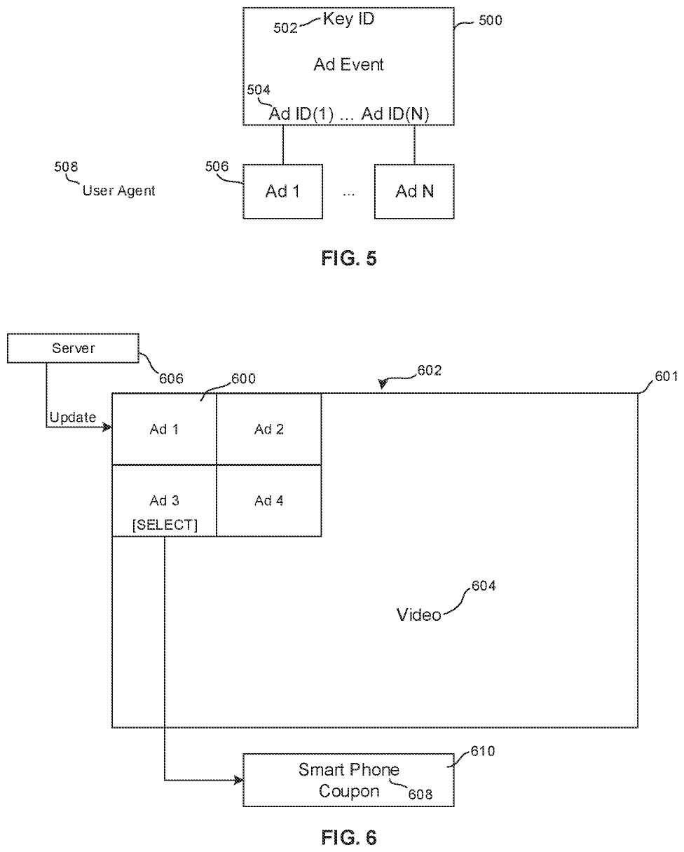

FIG. 5 illustrates that an ad event 500 typically may be associated with a key ID 502, which may be a unique alpha-numeric string identifying the ad event. Each key ID can have multiple individual Ad IDs 504 (which also may be unique alpha numeric strings) assigned to it to create the entire Ad event, which includes plural ads 506. Ad events 500 signaled from broadcasters match up to targeted Ad IDs 504, which can be stored in the user agent 508 and/or a remote cloud server, so that an Ad event knows which ads to play.

In an example shown in FIG. 6, targeted ads 600 may replace a broadcast ad on a display 601 for local attribution, or multiple ads may be synchronized for display on a single “canvas” (a region of part or all of a display) with each ad having its own Ad ID and placed selectively on the TV canvas 602 for simultaneous viewing. The ads may be displayed in synchronization or timed with broadcast video 604, and they can also be progressively loaded and updated over time as well, such that the ad gets updated from, e.g., an Internet server 606 for continuous viewing. An example of this is a persistent ad avail during a live sports event, embodying the concept of a timed event. Such an ad event can include a batch of micro-ads 600 as shown that are added to the TV canvas 602 with each ad 600 being curated for the user based on user demographics and other user-specific information, meaning the ad event can be unique to the specific user. The micro-ads 600 can be fully addressable ads. For example, the ads 600 may relate to one car-model, based on a user profile, or the ads 600 may illustrate respective car models with a video of a sales event. The user may select an ad 600, which may trigger presentation of a coupon 608 that is called up and is savable to a smart phone 610 whose ID is associated with the display 601. Thus, on the same TV canvas 602 one or more ads may be displayed that are coordinated together.

Further, each ad 600 may have respective options for playback that can lead to different display outcomes or views, since they are in fact separate ads, managed individually.

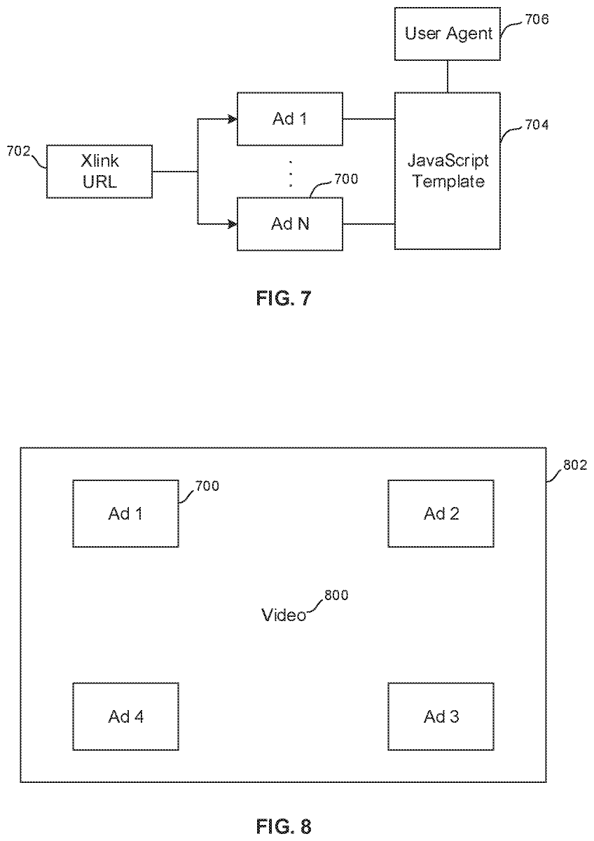

FIG. 7 illustrates that while plural ads 700 in a single Ad event can be called by an Xlink uniform resource locator (URL) 702, playback and placement of the ads 700 typically is controlled by an Ad template 704, typically implemented using JavaScript. The JavaScript template 704 includes a collection of instructions and commands on how to structure the canvas using the ads or using video program streams. Video templates manage video events. Ad templates manage ad events. Each ad event is managed by both an Xlink that triggers its associated JavaScript controls and then the JavaScript for the ad event that controls what ads get played out. The JavaScript for the X-link and in-band ads describe what the ads are in the “Ad Pack” and also tell the user agent what ad to grab depending on the tag associated with each ad. The template 704 knows where the ads should be placed on the canvas and manages the entire syncing and playout experience. In the use case of an overlay, the real time ad is put into the video ad cache or memory buffer for play, and when the Xlink arrives it is played out immediately. The JavaScript template 704 that comes with or is identified by an Xlink controls how the ad is retrieved, stored, and where on the canvas the ad is seen if it is a single ad playout.

Thus, the assortment and placement of the ads 700 on the display are managed by the Ad template JavaScript. This type of Ad event can exist in playthrough ad breaks, in which the ads 700 to appear around the main video 800 on a display 802 as shown in FIG. 8. Note that the Ad event key ID 502 in FIG. 5 may be correlated to the Ad template 704 in FIG. 7, such that the template 704 is called up from an Xlink and triggered by an ad avail. This is similar to an Xlink indicating an ad avail which is embedded in a program stream. The combination of the Ad event ID 502 and the micro-ad IDs 504 may correspond to the Ad template 704. Ads 700 are timed, mapped, and played from controls from the JavaScript of the Ad template 704.

Individual ads 700 may serve different functions. One ad 700 may be the video ad, and another ad 700 may be an overlay ad (essentially, an ad that replaces a broadcast ad with local attribution). Another ad 700 may be one of many products with a coupon call action. Thus, there are multiple playback options depending on the viewer's targeted characteristics.

As ad ID 504 may include a presentation time component (colloquially referred to as a time-to-live or TTL component) and specific canvas placement instructions usable by the JS template 704 to locate where the ad is to be placed on the canvas. Each ad event 500 can be made up of static and/or dynamic ads. The dynamic ads represent a portion of the ad package designed to create the functionality of the ad over time and what responses it will trigger if it is interactive and addressable.

As shown in FIG. 7, a TV user agent 706 controls the programmable Ad template 704. The user agent 706 may be established by a broadcaster app. The user agent 706 also handles calls from the ad event 500 to the various ads 506. Dynamic or smart ads can for example offer coupons or link to additional information about their messages. They can also call a replacement URL which display follow up information within the TTL of the ad tag. Viewers then see an ad progression or story based on likely scenarios proven by targeted ad characteristics, in that it has multiple dynamic playback options depending on the profile that is active in the user agent or smart TV.

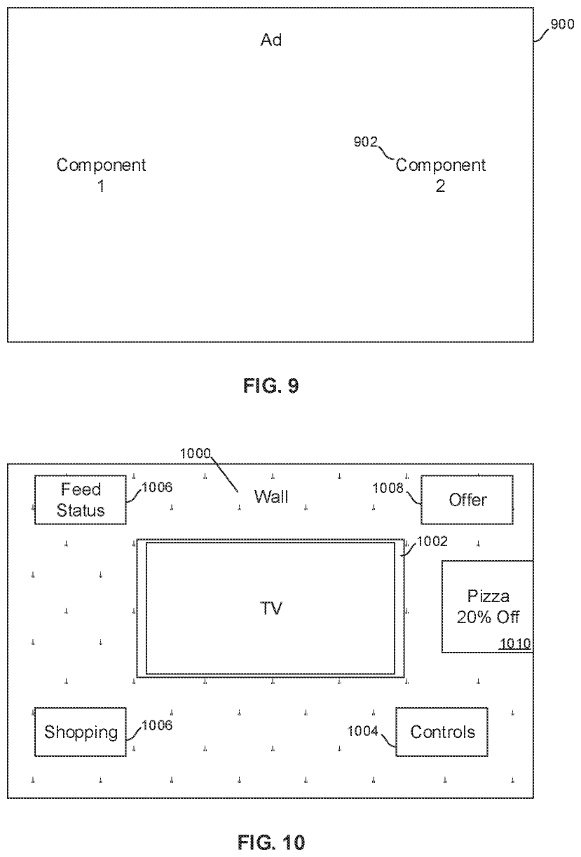

FIG. 9 illustrates an ad 900 that is made up of sub-components 902 that can be different to each user profile. This is the concept of a dynamic or updated ad display, whether is it targeted or not. How the canvas is made up or drawn may be based on management of the program template and Ad template 704 from the cloud (curated) or from the user agent running JavaScript that delineates each ad's function and placement.

Ad events are becoming more popular today as persistent TV viewing in sports is being used more often. An XLink need not be tied to one video. Multiple metadata sources can change what ad is played out based upon a viewer's historical viewing data (based on automatic content recognition (ACR) or web-based cookies). The combination or mix of ads, videos or overlays that are sent to the player by the content creator/broadcaster can be individualized for each program stream. That way user-based targeting is specific to the TV ID or device and also to the user profile. Thus, the concept of an ad event makes sense. Moreover, an ad event may indicate where an ad avail is listed coming up and also the ad avail could be addressable and controlled by an ad template. This ad event can be managed by both the broadcaster's targeting ad campaign and the user agent's data warehouse supporting targeting on the TV. It ultimately requires management and coordination of various X-links tags and associated metadata and programmable ad templates across both OTT and OTA networks with one video or a single canvas, and then can be expanded beyond that to MultiView events.

If the Ad event involves combining an ad package, then a template controls the ad event since an overall controller is required. Ads can be stored in the display or in the Cloud too, but presentation is improved if stored locally thus allowing it to be playout out live if necessary. If the broadcaster decides to curate the ad and video experience from the Cloud, then the pre-assignment of ads and control of the events comes with the in-band program stream and is called from a single URL. There are some efficiencies gained from Cloud-based controls in that a single video ad event and single video program stream can be delivered with the interactive portion managed on the TV as an overlay. So, the ads come pre-sync'd and the videos come pre-sync'd. However, this may require individual streaming sessions or several DASH manifests depending on the targeted user. If the user agent manages the events, then more individualized metadata can be applied in real time to each event based upon Event IDs, Ad event IDs, and templates.

Ad events can be handled for video-on-demand (VOD) streams and for live streams for different types of program types. The basic requirement is that the TV video player needs to be robust enough to handle the multiple streams of ad videos and program stream videos in a simultaneous manner. That puts key emphasis on ensuring that conflicts in stream architecture be resolved quickly. Thus, the TV should have a dynamic playback buffer or set of buffers than can be reallocated instantly as the canvas evolves during an event.

The possible uses for ad event management and program stream management come from TVs being smarter and larger over time. This will be the case for TV usage in general as objects are managed for placement on a home video wall. FIG. 10 illustrates a video wall 1000 with a TV 1002 and other home-based control systems 1004 being visible such that a snapshot of a home is visible all at once. This Internet of Things (IoT), smart home, or home automation dashboard has within it the ability to deliver an instant view of home time. Reminders of all sorts can be prioritized. Lists 1004 for shopping can be presented and status 1006 of home events also can be presented, such as baby feeding times, calendars for each member so parents know where the kids are, and reminders of planned events. Offers 1008 may be displayed that relate to time of day usage of the video wall 1000 so that there may be an artificial intelligence (AI) component to the entire day.

Timed messages 1010 designed for the viewer's lifestyle may be presented. These timed messages can be about what the viewer already show interests in so that the ad doesn't look like an ad anymore but rather may appear as a reminder about what the viewer already does regularly, and can be open to a curated suggestion, such as “today is pizza day, order now and get 20% off”, based on a history of past family dining.

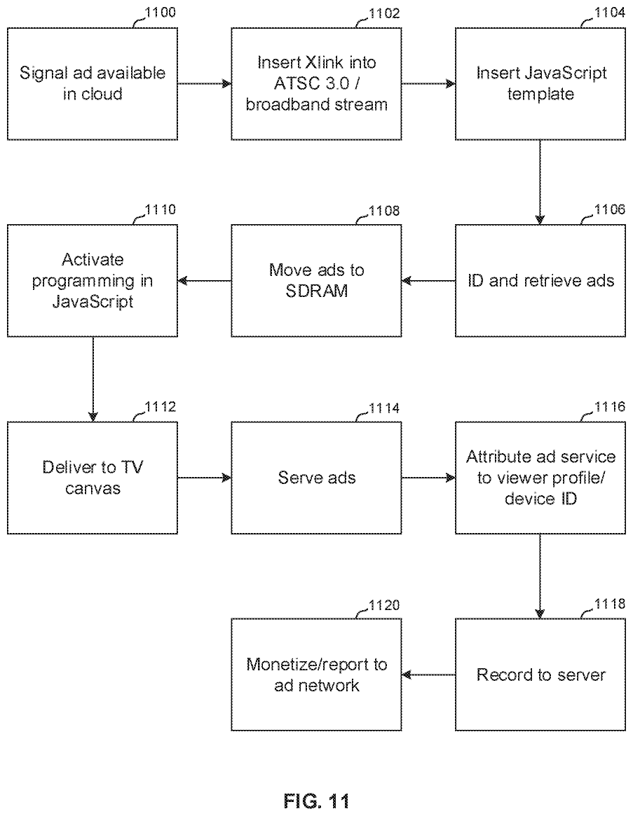

FIG. 11 illustrates example logic. Commencing at block 1100, an Ad avail is signaled in the Cloud (e.g., by the broadcaster's own ad traffic and billing system). Moving to block 1102, Ad avail signaling (such as an XLink) is inserted into the ATSC 3.0 or broadband video stream, e.g., in an MPD.

Proceeding to block 1104, the JavaScript Ad template 704 and Ad package are inserted into the Cloud Ad server (for broadband delivery) or downloaded to the TV using the recognized XLink URL embedded in the DASH video stream (for broadcast delivery). Moving to state 1106, the Ad template 704 identifies the ads for the event and then pulls them into cached memory of the display that is to present the ads for temporary storage. At block 1108 the ads are placed into real-time SDRAM memory for playout to the TV canvas in sync with timed video elements.

Block 1110 indicates that ad-specific programming is activated in the JavaScript of the template 704 that identifies and executes specific ad event functions other than simple playout of a video or ad overlay. At block 1112 the programmatic ads are delivered to the TV canvas, and at block 1114 are served in sync with videos on the TV canvas. Moving to block 1116, the ad receives attribution to the viewer's profile or Device ID for targeted follow-up and recorded at block 1118 to an ad management server that tracks the event playout details. Block 1120 indicates that monetization and/or reporting the campaign fulfillment requirements are accomplished by sending ad data and profile elements to the ad network.

Thus, ads within an ad template are managed (e.g., by the template 704) to provide the overall decision-making power of what the ad event entails, how each ad element is treated, how long the ad event lasts, which ads are included in the template, and specific instructions for each ad element based on a user profile. An Ad event is one where a single avail or XLink tag pulls an Ad template 704 which manages an Ad event which manages the playout of several ads at once which are timed and sync'd with the video playback and tied to whatever is playing in the video at the time.

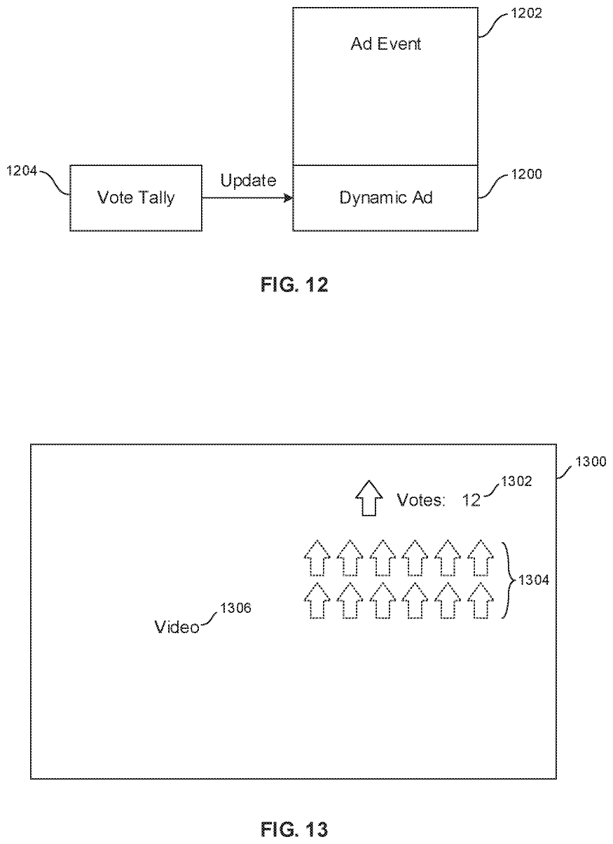

An ad event can be a sponsorship of an entire video period that lasts several minutes. FIG. 12 illustrates that a dynamic ad element 1200 can be subsumed within an Ad event 1202. A dynamic ad element is a programmatic, interactive, and addressable ad that can track its own playout, attribution, and progress through an Ad event. It is smart and acts more like a micro-service. The smart ad is in part controlled by the Ad template 704 for how it is placed and its timing relative to other ads during the video event. However, it is like an applet in that it is designed for events and for interactivity or targeting. The ad can evolve over time and can be managed by live data components. For example, it can update itself with the latest information relative to its message. An example of this kind of smart ad is a live vote tracker that tracks vote tallies 1204 for a televised event. In this way, a display 1300 as shown in FIG. 13 can present a vote tally card 1302 that is persistent throughout the ad break tallying the vote totals on screen for consumer voting, and can evolve as votes are counted as indicated by the dashed lines 1304. It also acts as part of the video event 1306 on screen so that it can be viewed during the video playout. The dynamic ad thus may establish a smart ad that has interactive and dynamic or live components to it. It may be shown during an ad break so the viewer can keep track of live vote tallies while giving them options to vote interactively. On top would be a sponsorship portion of the layout for branding.

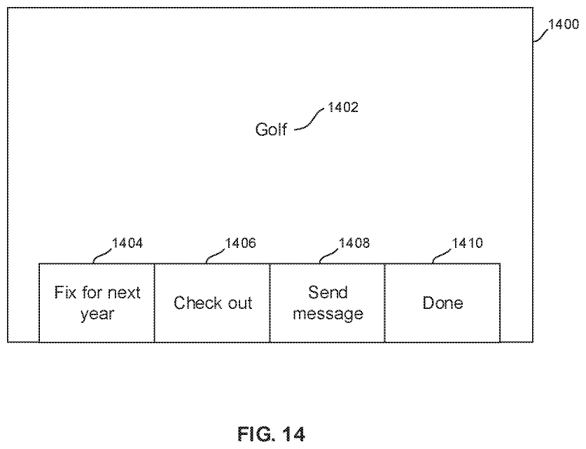

FIG. 14 illustrates another example in which a display 1400 presents a smart ad that progressively takes the viewer through a series of steps that leads the viewer to purchase of an advertised product. For example, if a golf event 1402 is presented, an ad 1404 for tickets for next year's event can be obtained by clicking on the ad. Selection of the ad 1404 for tickets causes a series 1406 of interactive ads to be presented based upon the user's profile, including a checkout and payment system. A component 1408 of the smart ad can send a message to a mobile device where the tickets can be accessed. The smart ad on the TV may track the user's progress and possibly show a percentage done indicator 1410.

It will be appreciated that whilst present principals have been described with reference to some example embodiments, these are not intended to be limiting, and that various alternative arrangements may be used to implement the subject matter claimed.

1. An assembly comprising:
at least one receiver device comprising at least one display, at least one broadcast signal receiver, and at least one processor configured with instructions which when executed by the processor configure the processor to:
receive from the broadcast receiver at least one audio video (AV) stream for live presentation of the AV stream on the display;
receive at least one non-real time (NRT) content comprising at least first and second advertisements of at least one ad event for insertion of the NRT content into the AV stream; and
present on the display the ad event in accordance with at least one Javascript template, wherein the ad event is managed by both an Xlink that triggers associated JavaScript controls and then the JavaScript template for the ad event, the template defining what ads get played out, and what the ads are in the ad event, a first ad of the ad event being stored in cache or memory buffer for play.

2. The assembly of claim 1, wherein presenting the first and second advertisements comprises presenting an ad event.

3-4. (canceled)

5. The assembly of claim 1, wherein the at least one template defines what advertisements in a group of advertisements are to be used as the first and second advertisements in the ad event.

6. The assembly of claim 1, wherein the at least one template identifies respective locations on the display at which each of the first and second advertisements is to be presented.

7. The assembly of claim 1, wherein the at least one template identifies respective durations for presenting the first and second advertisements.

8. The assembly of claim 1, wherein the at least one template is associated with a broadcaster application.

9. The assembly of claim 2, wherein the Xlink is received from the broadcast receiver or from a network server.

10. The assembly of claim 9, wherein the ad event is associated with at least first and second ad IDs identifying the respective first and second advertisements.

11. In a digital television system, a method comprising:
generating a signal of an advertisement availability (Ad avail);
inserting the signal into a video stream receivable by a receiver;
sending a template to the receiver using an XLink embedded in a dynamic adaptive streaming over hypertext transfer protocol (HTTP) (DASH) video stream;
using the template, identifying plural advertisements (ads);
storing the ads in cache or memory storage of the receiver as identified by the template; and
using the template, presenting the plural ads on a display of the receiver at locations and for durations controlled by the template.

12. The method of claim 11, wherein the video stream comprises a digital TV broadcast stream.

13. The method of claim 11, wherein the video stream is sent to the receiver from a network server.

14. The method of claim 11, wherein the signal comprises an Xlink.

15. The method of claim 11, wherein at least a first ad of the plural ads comprises computer software to update the first ad over time.

16. The method of claim 11, wherein at least a first ad of the plural ads comprises computer software to generate information useful for monetization.

17. A digital broadcast television (TV) assembly comprising:
at least one broadcaster assembly configured for broadcasting an audio video (AV) stream, non-real time (NRT) content being associated with the AV stream;
at least one receiver device configured for receiving the AV stream and the NRT content, the NRT content comprising at least first and second advertisements presentable on the receiver device together as a single ad event under control of a processor-executable Javascript template, wherein the ad event is managed by both an Xlink that triggers associated JavaScript controls of the Javascript template and then the JavaScript template for the ad event controls what ads get played out, the JavaScript template describing what the ads are in the ad event and where on the receiver device each ad is presented.

18. The assembly of claim 17, wherein the template defines what advertisements are to be used as the first and second advertisements.

19. The assembly of claim 17, wherein the template identifies respective locations on the receiver device at which each of the first and second advertisements is to be presented.

20. The assembly of claim 17, wherein the template identifies respective durations for presenting the first and second advertisements.
